(19) United States
(12) Patent Application Publication
(10) Pub. No.: US 2026/0078788 A1
(43) Pub. Date: Mar. 19, 2026

(54) LEDGER SLEEVE INSERT SYSTEM

(71) Applicant: Scott R. Brennan, Boca Raton, FL (US)

(72) Inventor: Scott R. Brennan, Boca Raton, FL (US)

(21) Appl. No.: 19/314,793

(22) Filed: Aug. 29, 2025

Related U.S. Application Data
(60) Provisional application No. 63/695,739, filed on Sep. 17, 2024.

(51) Int. Cl. F16B 13/12

(52) U.S. Cl. CPC F16B 13/124

(57) ABSTRACT

A ledger sleeve insert system, comprising a sleeve insert configured and dimensioned to be at least partially inserted into a bore of a ledger. The sleeve insert may include an aperture that traverses its entire length from a first end to a second end, the first end comprising a plate formed thereon. The aperture may be configured to receive a fastener that can traverse the sleeve insert and anchor to an underlying substrate. The sleeve insert may include one or more stabilizers formed along its outer periphery to prevent rotation when installed within a ledger. When installed, the plate can remain external to the ledger and abuts its outer surface, while the remainder of the insert, including the stabilizer(s), is nested within the ledger bore. The sleeve insert may be formed from metal or thermoplastic. Methods associated with the use and manufacturing of the sleeve insert are also described.

### CROSS REFERENCE TO RELATED APPLICATION(S)

This application claims the benefit under 35 U.S.C. § 119(e) to a U.S. Provisional Patent Application having Ser. No. 63/695,739 filed on Sep. 17, 2024. The above application is incorporated by reference herein in its entirety.

### BACKGROUND

### FIELD

The present disclosure relates to the field of construction and building technology. More specifically, it pertains to systems and methods for affixing structural components, such as ledger(s) (also known as ledger boards), to buildings and other structures. Even more specifically, the present disclosure relates to the installation of structural support systems in residential, commercial, and industrial construction, focusing on systems and methods for enhancing the structural integrity and long-term performance of attached elements, including protection against environmental stressors like wind forces and optimizing resource efficiency in installation processes.

### DESCRIPTION OF THE RELATED ART

The current methodologies for attaching ledger boards to buildings involve securing the ledger to a structure's framing using bolt type fasteners. A depiction of the traditional ledger board affixation to a substrate (such as concrete or masonry) is provided within the application(s) incorporated by reference. These systems are critical in supporting structures like roofs, floors, decks, and balconies where the ledger bears significant static and variable loads from both the structure(s) and external forces, such as wind.

Traditional attachment methods often rely on selecting the size of bolt diameter based on a bolt's rating and ability to provide resistance to shear, tensile, and compressive forces/stress. As such, the selection is limited in that, while larger bolts offer better mechanical performance, they present several challenges during installation and long-term performance; whereas smaller diameter bolts offer less mechanical performance, but are better suited for efficient and ease of installation. To compensate for lower mechanical performance, smaller bolts often must be installed at closer intervals across the width of a ledger to adequately distribute and resist the applied loads. This increased frequency of fasteners creates a denser bolt pattern, which introduces additional complications during installation. Precisely aligning multiple bolts at reduced spacing increases the likelihood of human error, such as misalignment, over drilling, or violating minimum edge or spacing distances as required by building codes or structural guidelines. Such errors can compromise the integrity of the connection, increase labor time, and heighten the risk of long-term structural failure. Additionally, densely spaced bolts can lead to stress concentrations and may exacerbate the risk of wood splitting under load, especially if the wood grain is oriented horizontally, as is typical with ledger boards.

Along these lines, one key challenge with large diameter bolts is ensuring precise alignment during installation. Their size increases the likelihood of misalignment due to applied forces and limited maneuverability. Misaligned bolts can lead to weaker connections and higher risk of failure under load. Additionally, the installation process is cumbersome, often requiring larger tools, more effort, and additional labor, which increases time, cost, and the chance of error.

In addition to installation difficulties, the reliance on larger diameter bolts (when compared to smaller diameter bolts) is driven by the need to increase the ledger's resistance to shear and tensile forces/stresses. While larger diameter bolts typically provide greater strength against these forces, this solution comes at the cost of added material expense and the potential for more complex construction requirements (as mentioned above).

Furthermore, wind forces create additional challenges for ledger boards. As wind flows across the surface of a building, it has the potential to generate internal positive pressure, create a pressure differential on the surface of the building wind is flowing onto, or create a pressure differential on the leeway side of the building (opposite that which the wind is flowing onto). These forces can pull a ledger into the wall/structure it is affixed to by nature of the pulling force acting on the bolts securing the ledger, possibly causing compressive force to act on the ledger from the bolt. Over time, or given a high enough force (perhaps from a wind gust), this can cause the wood of the ledger to split, particularly when the grain runs horizontally to the ground, which, as mentioned above, is a common orientation for ledger boards. This splitting weakens the connection between the ledger and the bolts, increasing the likelihood of structural and total failure, especially in high-wind environments.

The most common solution to prevent splitting of ledgers caused by wind forces is to reinforce the ledger with metal plates. These plates are installed along the exterior surface of the ledger to provide additional structural support, effectively redistributing forces across the ledger and preventing stress from concentrating in one area (such as at a bolt). However, while this solution addresses the problem of splitting, it introduces new complications. Metal plates are expensive, both in terms of material costs and labor to install. Additionally, when metal plates are placed directly against untreated or inadequately sealed wood, they can trap moisture at the interface, promoting wood rot over time. If the metal is not properly coated or galvanized, it may corrode, especially in high-humidity or coastal environments. Rusted metal can further stain or degrade the wood, and corrosion can reduce the structural effectiveness of the reinforcement, ultimately undermining the very protection it was intended to provide.

Thus, the current state of ledger attachment systems relies heavily on selecting and having to decide between the benefits/trade-offs that larger diameter bolts offer when compared to smaller diameter bolts. Also, cumbersome metal reinforcements are often employed to withstand forces to prevent wind-induced splitting. However, these solutions are costly, labor-intensive, and prone to installation challenges, leading to inefficiencies in both construction and long-term performance. There remains a need for improved systems and methodologies that reduces the complexity and cost of ledger installation while enhancing resistance to environmental forces and structural loads.

### SUMMARY

The present disclosure provides systems, methods of making such systems, and methods of using such systems to address persistent challenges in the construction industry related to affixing ledger boards to structural substrates. In particular, the solutions described herein aim to reduce installation complexity, minimize labor intensity, and mitigate long-term vulnerabilities associated with traditional fastening approaches. Additionally, the present disclosure introduces improvements that enhance installation efficiency, reduce material and labor costs, and provide more reliable structural performance. These solutions address the need for more effective load distribution, simplify compliance with structural and building code tolerances, reduce the risk of ledger splitting under environmental stressors such as wind, and streamline the installation process—without introducing new points of failure.

Accordingly, the present disclosure provides for a ledger sleeve insert comprising a sleeve insert configured and dimensioned to be at least partially inserted into a ledger and comprising an aperture configured and dimensioned to receive a fastener. The aperture may traverse the entire length of the sleeve insert and begin at a first end of the sleeve insert and terminating at a second end of said sleeve insert. Further, the first end of the sleeve insert may comprise a plate formed about the first end of said sleeve insert. The plate may comprise a plate outer periphery of a first circumference, wherein the sleeve insert may comprise a sleeve insert outer periphery of a second circumference, and wherein the aperture may comprise an inner periphery of a third circumference. The first circumference may be greater than the second circumference, where the second circumference may be greater than the third circumference.

The plate may comprise a rear face and the sleeve insert outer periphery may comprise at least one stabilizer. The at least one stabilizer may run from a first height above the sleeve insert outer periphery near the first end of the sleeve insert and intersect with the sleeve insert outer periphery near the second end of the sleeve insert.

Accordingly, the sleeve insert may be configured and dimensioned to be at least partially inserted into a ledger comprising a bore, wherein the second end of the sleeve insert can be configured and dimensioned to be inserted into the bore, wherein the entirety of the sleeve insert outer periphery, including the at least one stabilizer, may be nestled within the bore of the ledger. When the sleeve insert is at least partially inserted into a ledger comprising a bore, the rear face of the plate abuts an outer surface of the ledger, allowing the plate to remain exterior to the ledger.

Notably, the inner periphery of the aperture may comprise threads wherein the threads may be configured and dimensioned to receive a fastener with corresponding threads. As such, the aperture may be configured and dimensioned to receive a fastener via the fastener being inserted into the aperture at the first end of the sleeve insert, traversing the length of the sleeve insert, and exiting the sleeve insert at the second end. Therefore, when the sleeve insert is at least partially inserted into a ledger comprising a bore, the aperture allows a fastener to traverse the length of the sleeve insert and anchor into a substrate, fixing the sleeve insert to the ledger.

The sleeve insert may be formed of a thermoplastic, which can comprise an ultraviolet radiation-resistant additive. Alternatively, the sleeve insert may be formed of metal.

Further, the present disclosure provides for a sleeve insert configured and dimensioned to be at least partially inserted into a ledger and comprising an aperture configured and dimensioned to receive a fastener. The aperture may traverse the entire length of the sleeve insert and begin at a first end of the sleeve insert and terminate at a second end of the sleeve insert. The first end of the sleeve insert may comprise a plate formed about the first end of the sleeve insert wherein the sleeve insert may further comprise an outer periphery comprising at least one stabilizer. The at least one stabilizer may prevent rotation of the sleeve insert when the sleeve insert is at least partially inserted into a ledger. Accordingly, the outer periphery may have a circumference between 3 and 3.5 inches, wherein the sleeve insert may have a length between 2 and 5 inches, wherein the plate may have an outer periphery with a circumference between 4.5 and 5 inches, and wherein the aperture may have an inner periphery with a circumference between 1.5 and 2 inches.

Further, the at least one stabilizer may run from a first height above the sleeve insert outer periphery near the first end of the sleeve insert and intersect with the sleeve insert outer periphery near the second end of the sleeve insert. The first height of the at least one stabilizer runs from may be between 0.15 and 0.40 inches.

Accordingly, the sleeve insert may be configured and dimensioned to be at least partially inserted into a ledger comprising a bore, wherein the second end of the sleeve insert may be configured and dimensioned to be inserted into the bore, wherein the entirety of the sleeve insert outer periphery, including the at least one stabilizer, may be nestled within the bore of the ledger and wherein the rear face of the plate may abut an outer surface of the ledger, allowing the plate to remain exterior to the ledger. As such, when the sleeve insert is at least partially inserted into a ledger comprising a bore, the aperture may allow a fastener to traverse the length of the sleeve insert, through the aperture, and anchor into a substrate, fixing the sleeve insert to the ledger. Here again, the sleeve insert may be formed of a thermoplastic, which can comprise an ultraviolet radiation-resistant additive. Alternatively, the sleeve insert may be formed of metal.

Further, the present disclosure also provides for a method of installing a ledger sleeve insert system, comprising boring a first aperture through a ledger and into a substrate. Thereafter, a second aperture may be bored into the ledger, said second aperture having a greater diameter than the first aperture and encompassing the first aperture. A sleeve insert may then be inserted into the second aperture, wherein the sleeve insert comprises an internal aperture configured to receive a fastener. A fastener may be inserted through the sleeve insert, traversing its length and anchoring into the substrate. In this configuration, the sleeve insert remains at least partially nestled within the ledger, while the fastener secures the ledger to the substrate. The sleeve insert may include one or more stabilizers to prevent rotation within the ledger during installation, and a plate at its outer end to abut the outer face of the ledger, thereby improving compression and load distribution across the ledger surface.

The present disclosure also contemplates methods of manufacturing a ledger sleeve insert (and systems related thereto as described herein) using mold-based fabrication techniques. Accordingly, a mold cavity may be configured and dimensioned to define a sleeve insert comprising a first end, a second end, and an aperture traversing its full length. A moldable material, such as a thermoplastic, may be injected into the mold to form the body of the sleeve insert. During the molding process, one or more stabilizers may be formed along the outer periphery of the sleeve insert to resist rotational movement (of the sleeve insert) during installation in a ledger or post-installation of the sleeve insert in a ledger. Additionally, a plate may be integrally formed about the first end of the sleeve insert, wherein the plate may be configured and dimensioned to remain exterior to the ledger and abut the outer surface thereof. The aperture of the sleeve insert may optionally include internal threads formed during molding to receive a threaded fastener. Upon completion of the molding and cooling or curing process, the sleeve insert may be removed and prepared for use in the system and method described herein. Additionally, although injection molding may be used to produce the sleeve insert (and systems associated therewith), the sleeve insert may be formed via other manufacturing techniques, including but not limited to extrusion, compression molding, thermoforming, machining, casting, stamping, or additive manufacturing. In embodiments where the sleeve insert is formed of metal, suitable methods may include CNC machining, metal injection molding, investment casting, die casting, forging, or any other conventional or advanced metal-forming process.

The present disclosure also addresses practical implication of theoretical and structural considerations related to enhancing the load-bearing capacity of ledger connections through improved stress distribution. By forming a bore within the ledger having a diameter greater than that of the fastener used to affix the ledger to a substrate, the resulting increase in bearing surface area can significantly reduce stress concentrations within the ledger material. This redistribution of applied forces helps mitigate localized failures, such as splitting or cracking, particularly in wood ledgers where grain orientation can compound stress vulnerabilities. When paired with an insert configured to fill the oversized bore (which need not be circular in shape) and receive a fastener therein, applied loads—including tensile, shear, and bi-axial forces—may be more evenly transferred into the surrounding ledger material, improving both connection strength and long-term performance under environmental stressors such as wind uplift and vibration.

### BRIEF DESCRIPTION OF THE DRAWINGS

For a fuller understanding of the nature of the present disclosure, reference should be had to the following detailed description taken in connection with the accompanying drawings in which:

FIG. 1 is a front perspective view of a ledger sleeve insert system.

FIG. 2 is a rear perspective view of a ledger sleeve insert system.

FIG. 3 is an alternative rear perspective view of a ledger sleeve insert system.

FIG. 4 is a side view of a ledger sleeve insert system.

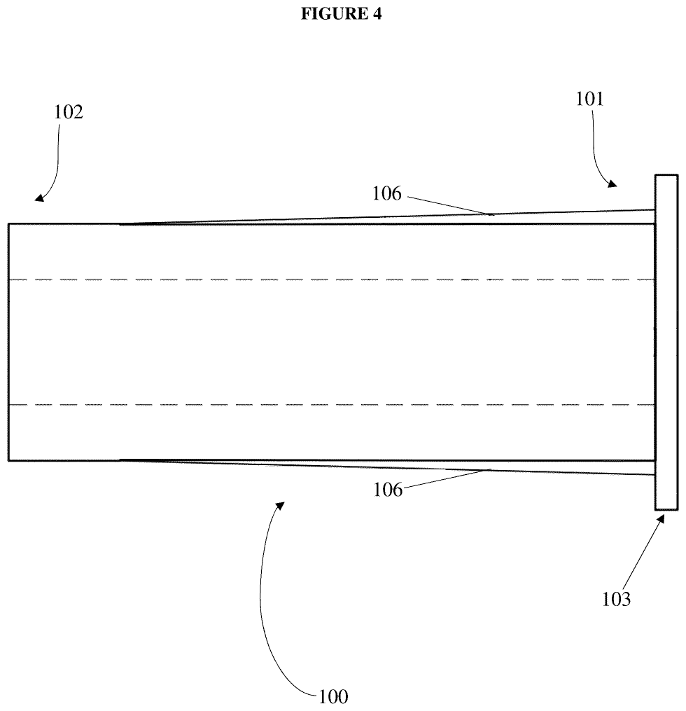

FIG. 5 is a front view of a ledger sleeve insert system.

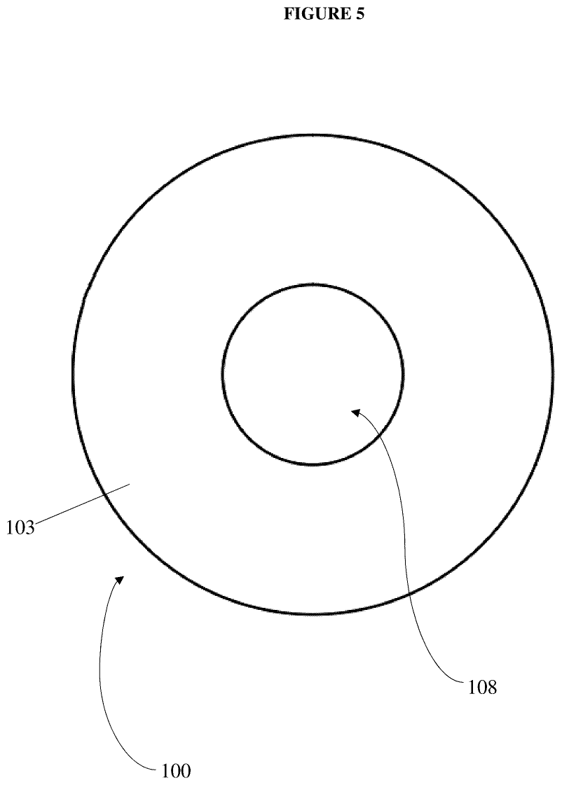

FIG. 6 is a side perspective view of a ledger sleeve insert system and corresponding ledger with a bore able to receive the ledger sleeve insert system.

FIG. 7 is a side perspective view of a ledger sleeve insert system being inserted into a ledger.

FIG. 8 is a side perspective view of a ledger sleeve insert system being inserted into a ledger with a fastener inserted into the ledger sleeve insert system and penetrating a substrate, the fastener anchoring the ledger to the substrate and fixing the ledger sleeve insert system to the ledger.

Like reference numerals refer to like parts throughout the several views of the drawings.

### DETAILED DESCRIPTION

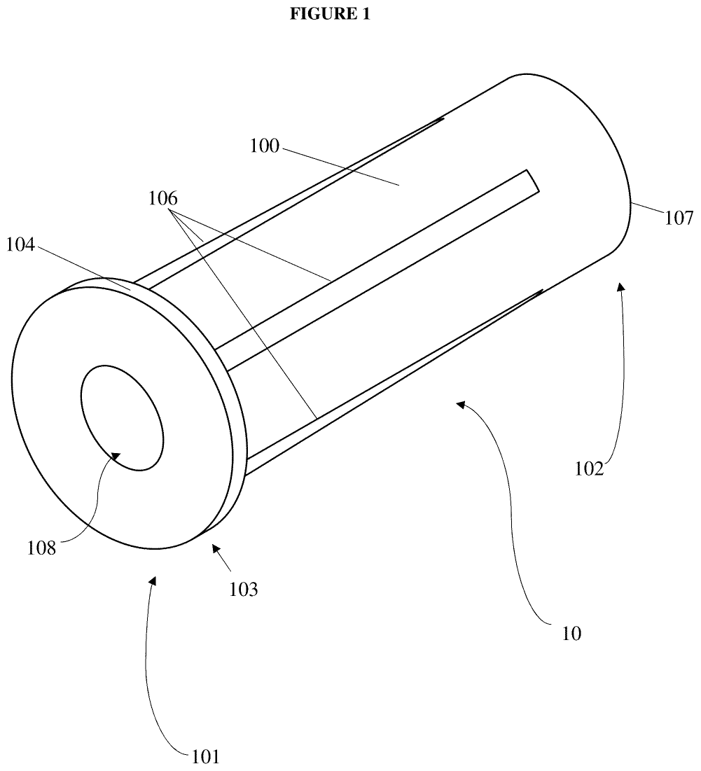

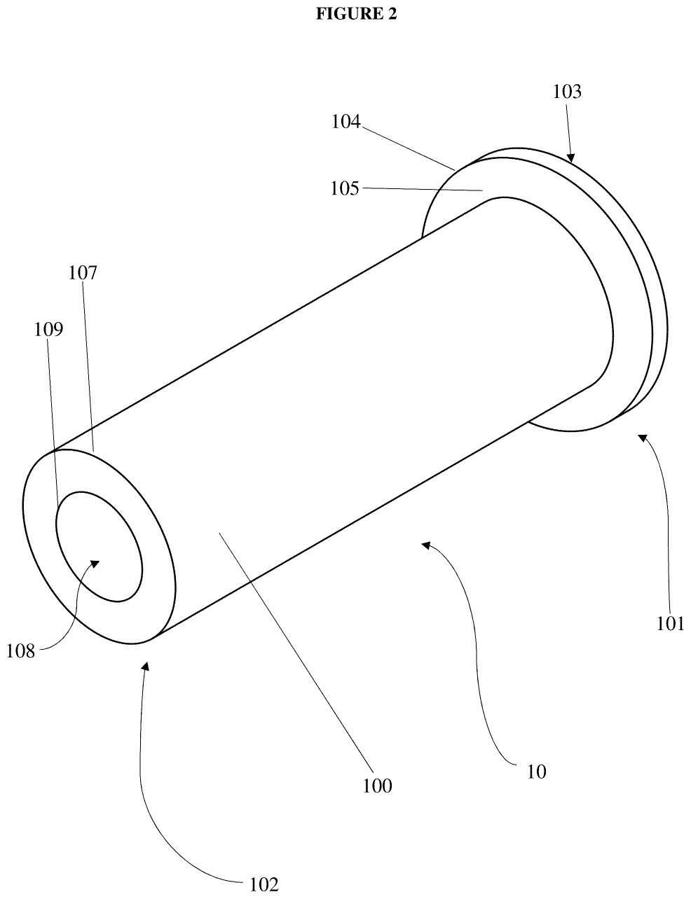

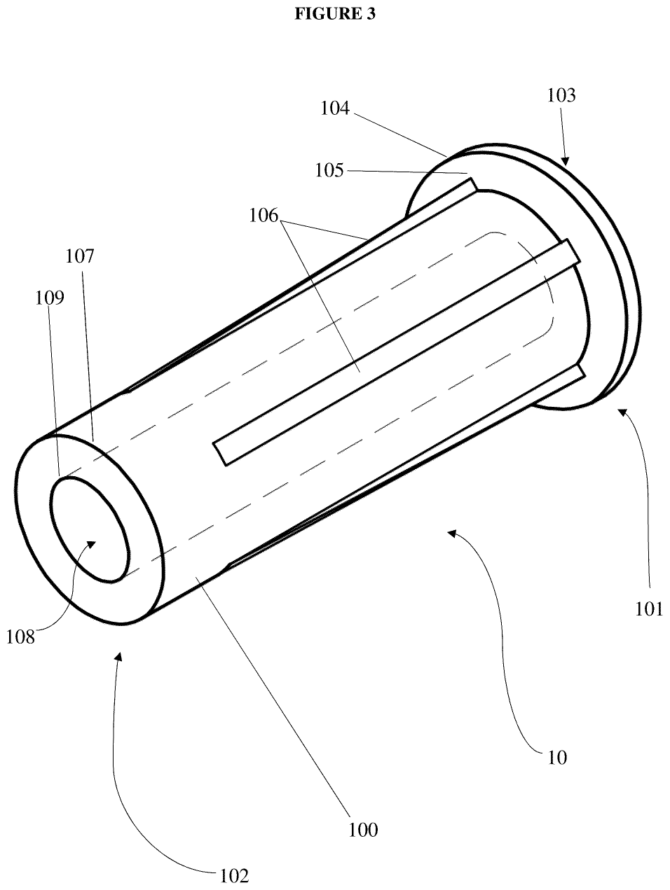

Turning now descriptively to the figures, FIG. 1 is a front perspective view of a ledger sleeve insert system 10. As shown, the ledger sleeve insert system 10 includes a sleeve insert 100 having a first end 101 and a second end 102. The first end 101 is provided with a plate 103, the plate 103 having a plate outer periphery 104 that extends radially outward beyond the sleeve insert outer periphery 107 to provide a greater surface area for contact against an exterior surface of a ledger L during installation (as will be described). With brief reference to FIGS. 2 and 3, the plate 103 further includes a rear face 105 which can, when the insert 100 is installed within a ledger L, rest in abutting and parallel relation to the ledger L surface. That said, a plate 103 may not be present in all instances of the system 10 or sleeve insert 100.

Continuing, the sleeve insert 100 may further comprise at least one stabilizer 106 formed along the sleeve insert outer periphery 107. In FIG. 1, the stabilizers (of which there are four, one not viewable) 106 extend longitudinally from a location proximate the first end 101 and plate 103 toward the second end 102, intersecting with the sleeve insert outer periphery 107 near the second end 102. Accordingly, the stabilizers are downward sloping in geometry, running from a first height above the sleeve insert outer periphery 107 and proximate the first end 101 to a second height that is at or about even with the sleeve insert outer periphery 107 and proximate the second end 102. As such, the stabilizers 106 may be raised above the outer periphery 107 and dimensioned to engage an interior surface of a ledger bore LB (as will be described), thereby resisting rotational movement of the sleeve insert 100 during installation of a fastener F (as will be described) and while the insert 100 is in service after installation. The inclusion of the stabilizers 106 may also promote alignment of the sleeve insert 100 within the ledger bore LB, ensuring that the aperture 108 (as is described below) remains coaxially aligned with the bore LB and with a corresponding pilot hole into the substrate S (as will also be described). However, as may be apparent with reference to FIG. 2, the system 10 may not incorporate stabilizers 106.

With continued reference to FIG. 1, and with brief reference to FIG. 3, an aperture 108 traverses the entire length of the sleeve insert 100, beginning at the first end 101 and terminating at the second end 102. FIG. 3 may be referenced to show stippled lines representing the aperture 108 traversing the length of the sleeve insert 100. The aperture 108 defines an aperture inner periphery 109 which may be smooth, threaded, or comprise a dimensioning or feature to engage a fastener F. Where the aperture inner periphery 109 is threaded, it may be configured and dimensioned to receive a threaded portion of a fastener F, such as a bolt or lag screw, allowing the fastener F to be driven through the sleeve insert 100 and anchored into the substrate S. The aperture inner periphery 109 may also be unthreaded, allowing a fastener F to pass freely through, although with tight tolerance, allowing the fastener F to still anchor to a substrate S, while being engaged by the insert 100. As may be apparent, the diameter of the aperture 108 is less than that of the sleeve insert outer periphery 107, thereby providing a wall thickness sufficient to distribute radial and axial loads imparted by the fastener F into the ledger L over a greater surface area.

The dimensional relationships between the plate outer periphery 104, the sleeve insert outer periphery 107, and the aperture inner periphery 109 may be selected to optimize performance for a given application. For example, the plate outer periphery 104 may have a circumference greater than that of the sleeve insert outer periphery 107 to increase bearing area of the rear face of the plate 105 upon a ledger L, while the sleeve insert outer periphery 107 may have a circumference greater than that of the aperture inner periphery 109 to provide adequate material strength and stiffness.

Although the sleeve insert 100 may be dimensioned as described herein, such dimensions should not be considered as limiting, as the sleeve insert 100 may be produced in a variety of dimensions to achieve a desired balance of structural performance, material efficiency, and compatibility with standard construction practices across different environments. For example, the outer periphery 107 of the sleeve insert 100 may have a circumference between approximately 3 and 3.5 inches, while the overall length of the sleeve insert 100 may range between approximately 2 and 5 inches to accommodate various ledger thicknesses and installation requirements. The plate 103, formed about the first end 101, may have an outer periphery 104 with a circumference between approximately 4.5 and 5 inches. The aperture inner periphery 109, which defines the passage for the fastener F, may have a circumference between approximately 1.5 and 2 inches, ensuring that the wall thickness between the aperture 108 and the sleeve insert outer periphery 107 is sufficient to resist deformation under tensile, shear, and compressive loads. The aperture inner periphery 109 may also be dimensioned to accommodate standard fastener geometries and dimensioning. As described, where there is at least one stabilizer 106, the stabilizer may run from a first height above the sleeve insert outer periphery 107 near the first end 101, such height being between approximately 0.15 inches and 0.40 inches, and slope downward toward the second end 102 to merge with the sleeve insert outer periphery 107.

Moreover, the sleeve insert 100 may be formed from a wide range of materials selected to satisfy desired performance, durability, and environmental resistance characteristics. The sleeve insert 100 may be formed of metallic materials, such as steel, stainless steel, galvanized steel, aluminum, brass, bronze, or titanium. Such a composition can be further treated or coated, for example, with zinc plating, anodizing, powder coating, or other corrosion-resistant finishes to extend service life in high-humidity, coastal, or otherwise corrosive environments.

Alternatively, the sleeve insert 100 may be formed of non-metallic materials, including thermoplastics such as nylon, acetal, polycarbonate, polyethylene, polypropylene, ABS, PEEK, or reinforced resins. These thermoplastic compositions may incorporate fillers or additives to improve specific performance characteristics, such as glass fiber reinforcement for increased stiffness, lubricants for reduced installation friction (or less friction), flame-retardant additives for compliance with building codes, and ultraviolet (UV) stabilizers to resist degradation from sunlight exposure.

Further still, the sleeve insert 100 may be produced from thermosetting materials, such as epoxy resin composites, phenolic resin systems, or fiber-reinforced polymers (FRP) using carbon fiber, fiberglass, aramid, or basalt fibers. Such composite materials may be selected for their combination of high strength-to-weight ratio, dimensional stability, and corrosion resistance. With such compositions, hybrid constructions may be employed, wherein a metallic sleeve body is over molded or coated with a polymer or composite material to provide both mechanical robustness and environmental protection. Other suitable materials may include ceramics, high-density laminates, or emerging engineered materials designed to withstand mechanical loads, chemical exposure, thermal cycling, and long-term weathering in a variety of installation environments.

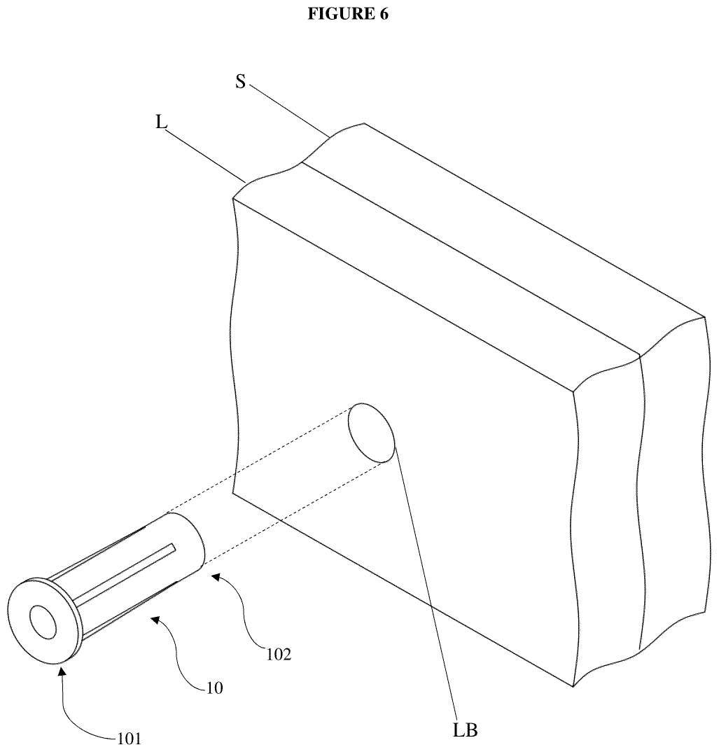

Turning now to FIG. 6, FIG. 6 is a side perspective view depicting the ledger sleeve insert system 10 positioned for insertion into a ledger L. As illustrated, the sleeve insert 100 is aligned such that its longitudinal axis is substantially coaxial with the longitudinal axis of a ledger bore LB. Accordingly, dotted lines represent the path of travel an insert 100 may take to be inserted into a ledger bore LB (and ultimately, ledger L). The first end 101 of the sleeve insert 100, including the plate 103, faces toward the exterior surface of the ledger L, while the second end 102 is directed toward the interior of the ledger L and toward the substrate S located behind it.

Although previously described, for clarity of FIG. 6, the sleeve insert 100 is spaced apart from the ledger L, showing its pre-installation positioning relative to the ledger bore LB. The ledger bore LB is dimensioned to receive the sleeve insert 100 in a manner that allows the sleeve insert outer periphery 107, including any stabilizers 106, to interface with the interior surface of the ledger bore LB once insertion begins. This alignment facilitates a guided installation path, ensuring that the aperture 108 of the sleeve insert 100 will be in coaxial registration with the ledger bore LB and any corresponding aperture or pilot hole formed in the substrate S. The perspective view further illustrates the manner in which the sleeve insert 100 approaches the ledger L, preparing for seating of the plate 103 against the exterior face of the ledger L when fully inserted.

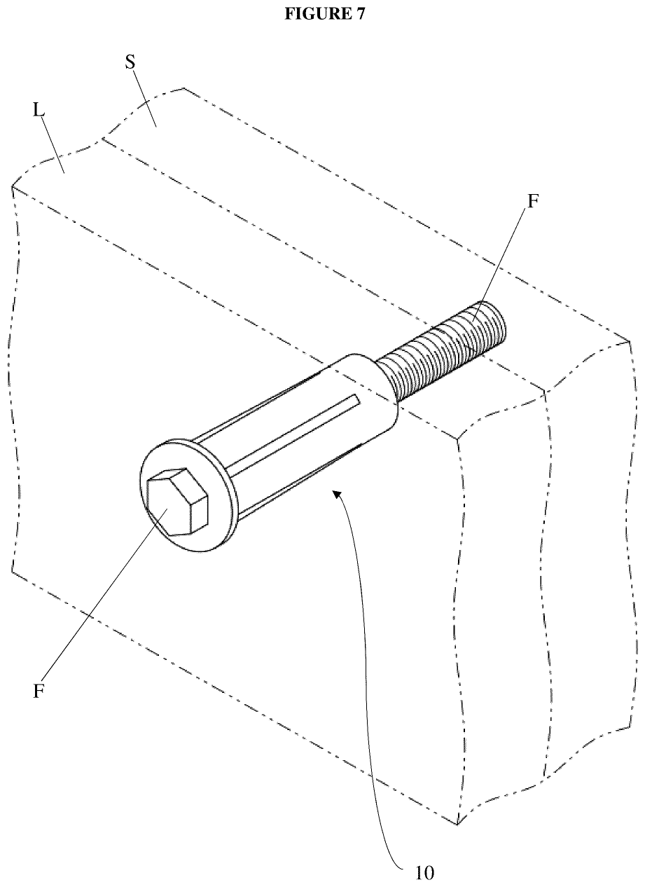

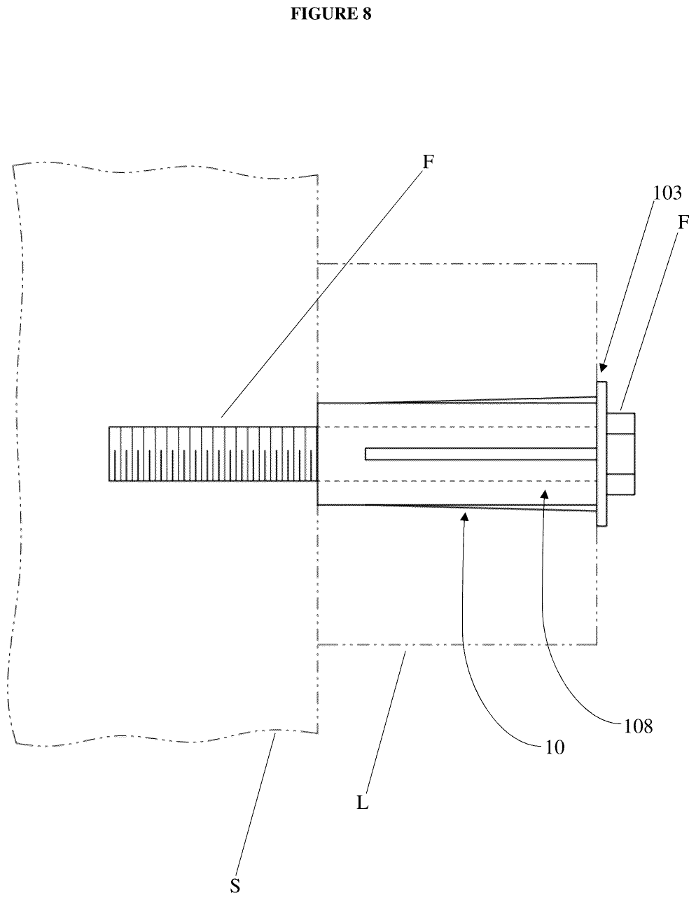

Turning now to FIGS. 7 and 8, the figures are a side perspective view and side view, respectively, depicting the ledger sleeve insert system 10 installed within a ledger L, with the ledger L and substrate S depicted in transparent form to better illustrate the orientation and positioning of the present disclosure. Accordingly, the sleeve insert 100 inner periphery 107 is nested within the ledger bore LB, with the first end 101 and plate 103 (and rear thereof 105) resting flush against the exterior surface of the ledger L. The second end 102 extends inwardly toward the substrate S, with the aperture 108 of the sleeve insert 100 aligned along a longitudinal axis. A fastener F is shown traversing the aperture 108 of the sleeve insert 100, extending through the ledger L, and penetrating into the substrate S where it is anchored. This orientation demonstrates how the ledger sleeve insert system 10 functions as an intermediary structure between the ledger L and the fastener F, transmitting loads in a controlled and distributed manner.

In use, the sleeve insert 100 is first aligned coaxially with the ledger bore LB (as illustrated in FIG. 6) and advanced into the bore until the rear face 105 of the plate 103 comes into abutting engagement with the exterior surface of the ledger L. At this point, the at least one stabilizer 106 (if present on the system 10) engages the inner wall of the ledger bore LB, preventing rotation of the sleeve insert 100 during subsequent fastener installation. Following placement of the sleeve insert 100, the fastener F is inserted into the aperture 108 from the first end 101, passing through the length of the sleeve insert 100 and extending beyond the second end 102 into the substrate S. The fastener F is then driven into the substrate S—whether by threading, expansion, or other anchoring means—until a secure mechanical engagement is achieved. To anchor into the substrate S means that the fastener F can have a mechanically interlocked, gripped, or otherwise formed a secure bond with the substrate material, thereby resisting withdrawal and transferring applied forces into the structural mass of the substrate S. Notably, the although not depicted, the fastener F may also leverage a washer that can rest between the fastener F, plate 103 (if present on the system 10) or first distal end 101 of the sleeve insert 10. By way of example, a washer may abut the ledger L (and plate 103 or first distal end 101 of the sleeve insert 10) and be pressed against the ledger L (and plate 103 or first distal end 101 of the sleeve insert 10) via the fastener. In such an instance, if a plate 103 is present upon the system 10, the washer may be of large diameter than the plate 103.

Compared to directly driving a bolt or similar fastener through the ledger L and into the substrate S, the use of the sleeve insert 100 provides significant performance enhancements. Without the sleeve insert 100, the fastener F would concentrate stresses at localized contact points along the ledger L (or portions of the grain thereof), increasing the likelihood of splitting, especially under tensile or wind-induced loading. The sleeve insert 100 addresses this by increasing the bearing surface area between a fastener F (or any other device inserted in a ledger L) and the ledger L through the wall thickness of the sleeve insert outer periphery 107, distributing axial, shear, and bi-axial forces more evenly across the ledger material. Furthermore, because the sleeve insert 100 is dimensioned with a larger outer diameter than the fastener F, the interface between the sleeve insert outer periphery 107 and the ledger bore LB carries a greater portion of the applied load, reducing concentrated stresses in the ledger L itself.

The plate 103 contributes additional structural benefits. By abutting the exterior surface of the ledger L, the plate 103 acts as a compression cap, holding the wood fibers or other ledger material together in the area surrounding the ledger bore LB. Under tensile or wind uplift forces, the plate 103 distributes these forces radially outward over a larger surface area, reducing the risk of the ledger L failing at the bore location. This structural reinforcement is particularly advantageous in conditions where environmental forces, such as gusting winds or cyclic loading, could otherwise induce progressive damage to the ledger L. In this way, the system 100 provides a robust, durable, and repeatable connection method that extends the service life of the ledger-to-substrate interface while maintaining installation efficiency.

Although not depicted, the present disclosure further encompass methods of installing a ledger sleeve insert system in various environments and under different construction practices. Such methods can include boring a first aperture through a ledger and into an underlying substrate, followed by forming a second aperture within the ledger that may be concentric with the first and of greater diameter, optionally to a depth sufficient to seat a sleeve insert 100 in a recessed or flush configuration. Alternatively, both apertures can be produced in a single step through the use of stepped drilling tools or other suitable equipment. A sleeve insert 100 may then be positioned within the second aperture (which can be a ledger bore LB), with its internal aperture 108 configured to receive a fastener F that extends through the insert 100 and engages with the substrate S. The insert's plate 103, if present, may abut the outer surface of the ledger L, potentially aiding in load distribution.

In certain variations, optional measures may be implemented during installation to enhance performance. For example, stabilizers 106 formed on the outer periphery 107 of the sleeve insert 100 may resist rotational movement during fastening, and sealing compounds or adhesives may be applied around the insert 100 to mitigate moisture ingress or aid in retention within a ledger L. The fastener F may be driven to a predetermined torque or depth, allowing the sleeve insert 100 to remain at least partially nestled within the ledger L while providing a secure connection to the substrate S. This general installation approach may be adapted for both new construction and retrofit applications, with aperture sizes, insert dimensions, and fastener types selected to achieve a balance between mechanical performance and compatibility with standard building practices.

Further, methods of manufacturing the sleeve insert 100 and related components using mold-based fabrication techniques (among others) are described herein. A mold cavity may be configured and dimensioned to produce an insert 100 having a first end, a second end, and an aperture traversing its entire length. Moldable materials such as thermoplastics (or other materials described herein) can be injected into the mold to form the main body of the insert, with features such as stabilizers and plates potentially being integrally molded. The molding process may allow for the incorporation of internal threads or other fastener-receiving features directly into the insert.

Alternatively, additional or alternative manufacturing techniques may be used. These can include extrusion, compression molding, thermoforming, machining, casting, stamping, additive manufacturing, or hybrid processes which can be a combination of techniques. For metal inserts, conventional or advanced metal-forming processes such as CNC machining, metal injection molding, investment casting, die casting, or forging may be suitable. Post-processing treatments—such as heat treatment, anodizing, passivation, or shot peening—may be performed to improve mechanical strength, wear resistance, or corrosion performance. Production may occur in single or multi-cavity tooling configurations to accommodate desired manufacturing volumes.

From a structural perspective, the disclosure may address the redistribution of stresses within a ledger by increasing the bearing surface area around a fastener connection. By forming an oversized bore relative to the fastener diameter and inserting a component configured to fill that bore, localized stress concentrations can be reduced, potentially mitigating failures such as splitting or cracking—particularly in wood members where grain orientation may exacerbate stress points. This can assist in preserving the integrity of the ledger over time, even when subjected to tensile, shear, or multi-directional loads. Accordingly, the sleeve insert 100 described herein may be reduced to an insert having an outer periphery configured and dimensioned to be inserted into a ledger bore, the sleeve insert further comprising an inner periphery, the inner periphery formed by an aperture traversing the length of the sleeve insert configured and dimensioned to receive a fastener.

It is intended that all matters in the foregoing disclosure and shown in the accompanying drawings be interpreted as illustrative and not in a limiting sense.

What is claimed is:

1. A ledger sleeve insert system comprising:
a sleeve insert configured and dimensioned to be at least partially inserted into a ledger and comprising an aperture configured and dimensioned to receive a fastener; and
said aperture traversing the entire length of said sleeve insert and beginning at a first end of said sleeve insert and terminating at a second end of said sleeve insert.

2. The system of claim 1 wherein said first end of said sleeve insert comprises a plate formed about said first end of said sleeve insert wherein said plate comprises a plate outer periphery of a first circumference, wherein said sleeve insert comprises a sleeve insert outer periphery of a second circumference, and wherein said aperture comprises an inner periphery of a third circumference.

3. The system of claim 2 wherein said first circumference is greater than said second circumference and wherein said second circumference is greater than said third circumference.

4. The system of claim 2 wherein said plate comprises a rear face and wherein said sleeve insert outer periphery comprises at least one stabilizer.

5. The system of claim 4 wherein said at least one stabilizer runs from a first height above said sleeve insert outer periphery near said first end of said sleeve insert and intersects with said sleeve insert outer periphery near said second end of said sleeve insert.

6. The system of claim 5 wherein said sleeve insert is configured and dimensioned to be at least partially inserted into a ledger comprising a bore, wherein said second end of said sleeve insert is configured and dimensioned to be inserted into the bore, wherein the entirety of said sleeve insert outer periphery, including said at least one stabilizer, is nestled within the bore of the ledger.

7. The system of claim 6 wherein when said sleeve insert is at least partially inserted into a ledger comprising a bore, said rear face of said plate abuts an outer surface of the ledger, allowing said plate to remain exterior to the ledger.

8. The system of claim 7 wherein said inner periphery of said aperture comprises threads, wherein said threads are configured and dimensioned to receive a fastener with corresponding threads.

9. The system of claim 8 wherein said aperture is configured and dimensioned to receive a fastener via the fastener being inserted into said aperture at said first end of said sleeve insert, traversing the length of said sleeve insert, and exiting said sleeve insert at said second end.

10. The system of claim 9 wherein when said sleeve insert is at least partially inserted into a ledger comprising a bore, said aperture allows a fastener to traverse the length of said sleeve insert and anchor into a substrate, fixing said sleeve insert to the ledger.

11. The system of claim 1 wherein said sleeve insert is formed of a thermoplastic.

12. The system of claim 11 wherein said sleeve insert's thermoplastic formation comprises an ultraviolet radiation-resistant additive.

13. The system of claim 1 wherein said sleeve insert is formed of metal.

14. A ledger sleeve insert system comprising:
a sleeve insert configured and dimensioned to be at least partially inserted into a ledger and comprising an aperture configured and dimensioned to receive a fastener;
said aperture traversing the entire length of said sleeve insert and beginning at a first end of said sleeve insert and terminating at a second end of said sleeve insert;
said first end of said sleeve insert comprising a plate formed about said first end of said sleeve insert;
said sleeve insert further comprising an outer periphery comprising at least one stabilizer; and
wherein said at least one stabilizer prevents rotation of said sleeve insert when said sleeve insert is at least partially inserted into a ledger.

15. The system of claim 14 wherein said outer periphery has a circumference between 3 and 3.5 inches, wherein said sleeve insert has a length between 2 and 5 inches, wherein said plate has an outer periphery with a circumference between 4.5 and 5 inches, and wherein said aperture has an inner periphery with a circumference between 1.5 and 2 inches.

16. The system of claim 14 wherein said at least one stabilizer runs from a first height above said sleeve insert outer periphery near said first end of said sleeve insert and intersects with said sleeve insert outer periphery near said second end of said sleeve insert.

17. The system of claim 16 wherein the first height said at least one stabilizer runs from is between 0.15 and 0.40 inches.

18. The system of claim 14 wherein said sleeve insert is configured and dimensioned to be at least partially inserted into a ledger comprising a bore, wherein said second end of said sleeve insert is configured and dimensioned to be inserted into the bore, wherein the entirety of said sleeve insert outer periphery, including said at least one stabilizer, is nestled within the bore of the ledger and wherein said rear face of said plate abuts an outer surface of the ledger, allowing said plate to remain exterior to the ledger.

19. The system of claim 14 wherein when said sleeve insert is at least partially inserted into a ledger comprising a bore, said aperture allows a fastener to traverse the length of said sleeve insert, through said aperture, and anchor into a substrate, fixing said sleeve insert to the ledger.

20. The system of claim 1 wherein said sleeve insert is formed of a thermoplastic wherein said thermoplastic formation comprises an ultraviolet radiation-resistant additive.
